(19) United States
(12) Patent Application Publication
(10) Pub. No.: US 2025/0005453 A1
(43) Pub. Date: Jan. 2, 2025

(54) Knowledge Distillation Via Learning to Predict Principal Components Coefficients

(71) Applicant: Google LLC, Mountain View, CA (US)

(72) Inventors: Ehsan Amid, Mountain View, CA (US); Christopher James Fifty, Churchville, MD (US); Manfred Klaus Warmuth, Santa Cruz, CA (US); Rohan Anil, Lafayette, CA (US)

(21) Appl. No.: 18/710,814

(22) PCT Filed: Dec. 12, 2022
(86) PCT No.: PCT/US2022/052561

§ 371 Date: May 16, 2024

Related U.S. Application Data
(60) Provisional application No. 63/290,999, filed on Dec. 17, 2021.

(51) Int. Cl. G06N 20/00

(52) U.S. Cl. CPC G06N 20/00

(57) ABSTRACT

Provided is an approach for knowledge distillation based on exporting Principal Components approximations (e.g., Bregman representations) of one or more layer-wise representations of the teacher model. In particular, the present disclosure provides an extension to the original Bregman PCA formulation by incorporating a mean vector and orthonormalizing the principal directions with respect to the geometry of the local convex function around the mean. This extended formulation allows viewing the learned representation as a dense layer, thus casting the problem as learning the linear coefficients of the compressed examples, as the input to this layer, by the student network. Example empirical data indicates that example implementations of the approach improve performance when compared to typical teacher-student training using soft labels.

### RELATED APPLICATIONS

This application claims priority to and the benefit of U.S. Provisional Patent Application No. 63/290,999, filed Dec. 17, 2021. U.S. Provisional Patent Application No. 63/290,999 is hereby incorporated by reference in its entirety.

### FIELD

The present disclosure relates generally to machine learning. More particularly, the present disclosure relates to systems and methods that perform knowledge distillation from a teacher model to a student model by training the student model to predict the coefficients of a principal components representation of a layer representation produced by a layer of the teacher model.

### BACKGROUND

In the field of machine learning, knowledge distillation (“distillation”) refers to a set of techniques used for transferring information from typically a trained model (which is typically, but not always larger), called the teacher, to a model called the student (which is typically, but not always smaller). One goal of distillation is to improve the performance of the student model by augmenting the knowledge learned by the larger model to the raw information provided by the set of training examples. Since its introduction, various approaches have applied knowledge distillation to obtain improved results for language modeling, image classification, robustness against adversarial attacks, and other tasks and domains.

In certain existing approaches, the teacher's knowledge is typically encapsulated in the form of soft labels, which are usually smoothened further by incorporating a temperature parameter at the output layer of the teacher model. The student is trained to predict the labels generated by the teacher for a given training example. While existing distillation approaches do provide some benefit for reducing inference costs or memory usage (e.g., by providing a smaller or otherwise more efficient student model that has reduced latency and storage requirements), additional improvement on these aspects would be welcomed in the art.

### SUMMARY

Aspects and advantages of embodiments of the present disclosure will be set forth in part in the following description, or can be learned from the description, or can be learned through practice of the embodiments.

One example aspect is directed to a computer-implemented method to generate machine learning models having improved computational efficiency, the method comprising: obtaining, by a computing system comprising one or more computing devices, one or more training inputs; processing, by the computing system, the one or more training inputs with at least a portion of a teacher machine learning model to generate one or more layer representations at a layer of the teacher machine learning model; performing, by the computing system, a principal components analysis technique on the one or more layer representations generated by the layer of the teacher machine learning model to generate (i) one or more sets of coefficient values respectively for the one or more layer representations and (ii) a plurality of principal directions, wherein the set of coefficient values for each layer representation comprises a plurality of coefficient values respectively associated with the plurality of principal directions; and training, by the computing system, a student machine learning model to predict the one or more sets of coefficient values.

In some implementations, performing, by the computing system, the principal components analysis technique comprises performing, by the computing system, a Bregman principal components analysis technique. In some implementations, performing, by the computing system, the Bregman principal components analysis technique comprises further generating (iii) a generalized mean vector. In some implementations, the generalized mean vector comprises mean vector values that minimize a Bregman compression loss. In some implementations, the generalized mean vector comprises an inverse of an activation function of the layer of the teacher machine learning model applied to a mean of the one or more sets of coefficient values as an operator. In some implementations, performing, by the computing system, the Bregman principal components analysis technique comprises enforcing an orthonormality constraint expressed with a Riemannian metric. In some implementations, performing, by the computing system, the Bregman principal components analysis technique comprises performing a QR decomposition technique such that a transpose of a first factor matrix times the Riemannian metric times the first factor matrix equals an identity matrix.

In some implementations, obtaining, by the computing system, the one or more training inputs comprises obtaining, by the computing system, a plurality of training inputs; processing, by the computing system, the one or more training inputs with at least the portion of the teacher machine learning model to generate the one or more layer representations at the layer of the teacher machine learning model comprises processing, by the computing system, the plurality of training inputs with at least the portion of the teacher machine learning model to respectively generate a plurality of layer representations at the layer of the teacher machine learning model; performing, by the computing system, the principal components analysis technique on the one or more layer representations comprises performing, by the computing system, the principal components analysis technique on the plurality of layer representations to generate (i) a plurality of sets of coefficient values respectively for the plurality of layer representations and (ii) a plurality of principal directions, wherein the set of coefficient values for each layer representation comprises a plurality of coefficient values respectively associated with the plurality of principal directions; and training, by the computing system, the student machine learning model to predict the one or more sets of coefficient values comprises training, by the computing system, the student machine learning model to predict the plurality of sets of coefficient values.

In some implementations, training, by the computing system, the student machine learning model to predict the one or more sets of coefficient values comprises training, by the computing system, the student machine learning model to predict the one or more sets of coefficient values when given the one or more training inputs as input. In some implementations, training, by the computing system, the student machine learning model to predict the one or more sets of coefficient values comprises training, by the computing system, the student machine learning model to predict the one or more sets of coefficient values when given a prior layer representation as an input, the prior layer representation generated by a second layer of the teacher machine learning model that is prior to the layer of the teacher machine learning model.

In some implementations, the layer of the teacher machine learning model comprises a hidden layer and the one or more layer representations comprise one or more embeddings. In some implementations, the layer of the teacher machine learning model comprises an output layer and the one or more layer representations comprise one or more output probability representations.

In some implementations, the method further comprises, after training, by the computing system, the student machine learning model to predict the one or more sets of coefficient values: training, by the computing system, a prediction model to predict one or more ground truth labels associated with the one or more training inputs when given the one or more training inputs as input, the prediction model comprising the student machine learning model, a prediction head, and the plurality of principal directions. In some implementations, the method further comprises, simultaneous to training the student machine learning model to predict the one or more sets of coefficient values: training, by the computing system, the teacher machine learning model to predict one or more ground truth labels associated with the one or more training inputs when given the one or more training inputs as input; wherein performing, by the computing system, the principal components analysis technique comprises performing an online principal components analysis technique. In some implementations, the teacher machine learning model comprises a pre-trained model.

Another example aspect is directed to one or more non-transitory computer-readable media that collectively store instructions that, when executed by one or more processors of a computing system, cause the computing system to perform operations, the operations comprising: obtaining, by a computing system comprising one or more computing devices, one or more training inputs; processing, by the computing system, the one or more training inputs with at least a portion of a teacher machine learning model to generate a plurality of layer representations respectively at a plurality of layers of the teacher machine learning model; and for each of the plurality of layers: performing, by the computing system, a principal components analysis technique on the one or more layer representations generated at the layer to generate (i) one or more sets of coefficient values respectively for the one or more layer representations and (ii) a plurality of principal directions, wherein the set of coefficient values for each layer representation comprises a plurality of coefficient values respectively associated with the plurality of principal directions; and training, by the computing system, a respective student machine learning model to predict the one or more sets of coefficient values. In some implementations, the principal components analysis technique comprises a Bregman principal components analysis technique.

Another example aspect is directed to a computing system for generating machine learning predictions with improved efficiency, the computing system comprising: one or more processors; and one or more non-transitory computer-readable media that collectively store: a machine-learned prediction model, comprising: a plurality of principal directions generated by performance of a principal components analysis on a plurality of layer representations generated at a layer of a teacher machine learning model; a student machine learning model trained to predict a plurality of predicted coefficient values respectively associated with the plurality of principal directions when given a model input; and a prediction head configured to generate a model prediction based on the plurality of principal directions and predicted coefficient values; and instructions that, when executed by the one or more processors, cause the computing system to perform operations, the operations comprising: obtaining the model input; processing the model input with the student machine learning model to generate the plurality of predicted coefficient values; and processing the plurality of principal directions and predicted coefficient values with the prediction head to generate the model output.

In some implementations, the principal components analysis technique comprises a Bregman principal components analysis technique. In some implementations, the model input comprises an image and the model output comprises an image prediction.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

The attached Appendix, which is fully incorporated into and forms a portion of this disclosure, describes example implementations of the systems and methods described herein. The present disclosure is not limited to the example implementations described in the Appendix.

### BRIEF DESCRIPTION OF THE DRAWINGS

Detailed discussion of embodiments directed to one of ordinary skill in the art is set forth in the specification, which makes reference to the appended figures, in which:

FIGS. 1A and 1B depict block diagrams of an example approach to train and performance inference with models having improved computational efficiency.

FIGS. 2A and 2B depict block diagrams of an example approach to train and performance inference with models having improved computational efficiency.

FIGS. 3A and 3B depict block diagrams of an example approach to train and performance inference with models having improved computational efficiency.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Introduction

Generally, the present disclosure is directed to a novel approach for knowledge distillation based on exporting Principal Components approximations (e.g., Bregman representations”) of one or more layer-wise representations of the teacher model. In particular, the present disclosure provides an extension to the original Bregman PCA formulation by incorporating a mean vector and orthonormalizing the principal directions with respect to the geometry of the local convex function around the mean. This extended formulation allows viewing the learned representation as a dense layer, thus casting the problem as learning the linear coefficients of the compressed examples, as the input to this layer, by the student network. Example empirical data indicates that example implementations of the approach improve performance when compared, for example, to typical teacher-student training using soft labels.

More particularly, Principal Component Analysis (PCA) is perhaps one of the most commonly used techniques for data compression, dimensionality reduction, and representation learning. In the simplest form, the PCA problem is defined as minimizing the compression loss of representing a set of points as linear combinations of a set of orthonormal principal directions. More concretely, given [symbol] ={xᵢ∈ [symbol] } and k≤d, the PCA problem can be formulated as finding the mean vector m∈ [symbol] and principal directions V∈ [symbol] where V^{T}V=Iₖ such that the compression loss,

$$m , V , \{ {c}_{i} \} = arg {min}_{\{ \begin{matrix}\tilde{m} ∈ {ℝ}^{d} , \tilde{V} ∈ {St}_{d , k} , \\ \{ {\tilde{c}}_{i} ∈ {ℝ}^{k} \}\end{matrix} \}} {\sum }_{i} {‖ {x}_{i} - ( \tilde{m} + \tilde{V} {\tilde{c}}_{i} ) ‖}^{2} \qquad ( 1 )$$

is minimized.

Here, St_{d,k}={U∈ [symbol] : U^{T}U=Iₖ} denotes the Stiefel manifold of k-frames in [symbol] and cᵢ∈ [symbol] corresponds to the compression coefficients of xᵢ. The problem in Eq. (1) can be solved effectively in two steps. First, we note that m can be viewed as a constant shared representation for all points in [symbol] (for which the code length k=0) that minimizes the total compression loss. With this interpretation, the mean vector can be written as the minimizer of

$$m = arg {min}_{\tilde{m} ∈ {ℝ}^{d}} {\sum }_{i} {‖ {x}_{i} - \tilde{m} ‖}^{2} , ( @ )$$

for which, the solution corresponds to the geometric mean

$$m = \frac{1}{\vert x \vert} {\sum }_{i} {x}_{i} .$$

By fixing m, the solution for V and {cᵢ} can be obtained by enforcing the orthonormality constraints using a set of Lagrange multipliers and setting the derivatives to zero. The solution to V amounts to the the top-k eigenvectors of the covariance matrix 1/| [symbol] |Σᵢ(xᵢ−m)(xᵢ−m)^{T} and cᵢ=V^{T}(xᵢ−m) corresponds to the projection of the centered point onto the column space of V. Note that certain online variants of PCA alternatively apply a gradient step on V and project the update onto St_{d,k} by an application of QR decomposition.

Knowledge distillation refers to a set of techniques used for transferring information from (typically) a larger trained model, called the teacher, to a (typically) smaller model, called the student. The goal of distillation is to improve the performance of the student model by augmenting the knowledge learned by the larger model with the raw information provided by the set of train examples. Since its introduction, various approaches have applied knowledge distillation to obtain improved results for language modeling, image classification, and robustness against adversarial attacks.

The teacher's knowledge is typically encapsulated in the form of (expanded) soft labels, which are usually smoothened further by incorporating a temperature parameter at the output layer of the teacher model. Other approaches consider matching the teacher's representations, typically in the penultimate layer, for a given input by the student. Example implementations of the present disclosure explore the idea of directly transferring information from a teacher to a student in the form of learned (fixed) principal directions in arbitrary layers of the teacher model. One example focus for representation learning is on a generalized form of the PCA method based on the broader class of Bregman divergences. The Bregman divergence induced by the strictly-convex and differentiable convex function G: [symbol] → [symbol] between u, v∈domG is defined as

$${D}_{G} ( u , v ) = G ( u ) - G ( v ) - g ( v ) \cdot ( u - v ) , \qquad ( 3 )$$

where g=∇G is the gradient function (commonly known as the link function).

Bregman divergence is always non-negative and zero iff the arguments are equal. This broad class of divergences includes many well-known cases, such as the squared Euclidean and KL divergences as special cases. In addition, a Bregman divergence is not necessarily symmetric but satisfies a duality property in terms of the Bregman divergence between the dual variables. Let G*(u*)=sup_{z}z·u*−G(z) be the Legendre dual of G. Then, we can write D_{G}(u,v)=D_{G}*(v*,u*) where u*=g(u) and v*=g(v) are the pair of dual variables. When G is strictly convex and differentiable, we have g*=g⁻¹ and u=g*(u*) and v=g*(v*). Also, the derivative of a Bregman divergence with respect to the first argument takes the following simple form

$${∇}_{u} {D}_{G} ( u , v ) = g ( u ) - g ( v ) . \qquad ( 4 )$$

Example systems can leverage a natural way of generating layerwise Bregman divergences for deep neural networks as line integrals of the strictly monotonic transfer functions. Such Bregman divergences can be utilized for layerwise representation learning via an extension of the Bregman PCA algorithm.

Example implementations of the present disclosure perform representation learning using a generalized form of the PCA method based on the broader class of Bregman divergences. Thus, one aspect of the present disclosure is directed to a PCA formulation that includes a generalized mean vector to handle the non-centered data. Another example aspect improves the orthonormality constraint of the Euclidean geometry to the orthonormality in terms of the Riemannian metric induced by a Bregman divergence. This extended formulation of mean and the orthonormality constraint can include PCA in the Euclidean geometry as a special case. Another example aspect is directed to a variant of a QR decomposition to enforce the generalized orthonormality constraint efficiently. Also provided are techniques to handle the constrained case of orthonormal directions for the softmax link function.

One application of the proposed construction is for layer-wise representation learning of deep neural networks with strictly monotonic transfer functions. Example experiments show that even low-rank representations of input examples maintain the generalization properties of the original network. In particular, the present disclosure provides a new approach for knowledge distillation by incorporating the principal directions learned from the teacher model into the student model. The proposed extension of the Bregman PCA formulation allows viewing the learned representation as a dense layer. Thus, the distillation problem reduces to learning the corresponding coefficients for a given example by the teacher, which is fed as input to the dense layer.

The present disclosure provides a number of technical effects and benefits. As one example, the PCA-based approach described herein can facilitate learning of student models which demonstrate strong performance. In particular, the proposed distillation approaches enable distilling knowledge from a less efficient teacher model into a more efficient student model. The student model may be more efficient than the teacher model because it is: smaller (e.g., in number of parameters or FLOPS); has a different structure that may be less computationally expensive for certain hardware (e.g. feed-forward vs. convolutional or recurrent or transformer/autoregressive neural networks); and/or specifically designed for particular hardware (width, precision, etc.). Thus, the more efficient student model will require (e.g., as compared to the less efficient teacher) less computational resources to store and run. This results in a savings of computational resources such as processor usage, memory usage, network bandwidth, etc.

Furthermore, as shown in experimental data contained in the Appendix, student models trained using the proposed PCA-based approaches have superior performance (e.g., accuracy) as compared to prior standard approaches in which, for example, a student is trained to predict the soft labels of the teacher model. Thus, the proposed approaches represent an improvement in the performance of a computing system. In addition, the demonstrated performance improvements are even more apparent when the models are trained on a smaller number of training examples. This means that, using the proposed approach, student models can be trained using fewer training examples. Using fewer training examples corresponds to faster training, which in turn corresponds to conservation of computing resources such as processor usage, memory usage, network bandwidth, etc. Also, this property makes the method useful in settings where the amount of training data is limited and data augmentation is expensive to perform.

With reference now to the Figures, example embodiments of the present disclosure will be discussed in further detail.

### Example Extended Bregman PCA

Given a strictly convex and differentiable function F: [symbol] → [symbol] with link function ƒ=∇F, some example implementations of the present disclosure cast the generalized Bregman PCA problem as approximating xᵢ∈| [symbol] | as a linear combination of a set of orthonormal principal directions in the dual space. This formulation reduces to Eq. (1) for the choice of ƒ=id_{d}, which corresponds to the squared Euclidean divergence. However, before defining the objective function formally, this section discusses the problem of finding a generalized mean in the dual space as follows. Let [symbol] ={xᵢ∈domF*} be a set of given data points. Define the generalized mean vector m as the minimizer of the following objective,

$$m = arg {min}_{\tilde{m} ∈ domF} {\sum }_{i} {D}_{F} * ( {x}_{i} , f ( \tilde{m} ) ) . \qquad ( 5 )$$

Note that the above Eq. (5) is a direct generalization of Eq. (2) in terms of finding a shared constant representation for all points in [symbol] that minimizes a notion of Bregman compression loss. The following proposition states the solution of the generalized mean in a closed form. proposition gen mean The generalized dual mean in Eq. (5) can be written as

$$m = f * ( \frac{1}{\vert 𝒳 \vert} {\sum }_{i} {x}_{i} ) . \qquad ( 6 )$$

Thus, the dual mean simply corresponds to the dual of the arithmetic mean of the data points. When ƒ=id_{d}, the dual mean reduces to the arithmetic mean.

Given the definition of the dual mean in Eq. (6), this section now extends the vanilla PCA formulation in Eq. (1) to the class of Bregman divergences. First, note that the geometry of the space of principal directions is altered when switching from a squared loss to a more general Bregman divergence. Specifically, given the convex function G of a Bregman divergence, the inner-product is locally governed by the Riemannian metric,

$${D}_{G} ( u + δ u , u ) = {D}_{G} ( u , u + δ u ) \approx \frac{1}{2} δ {u}^{T} {H}_{G} ( u ) δ u ,$$

where δu is a small perturbation and H_{G}=∇²G is the Hessian of G. Thus, the definition of orthonormality needs to conform with the new geometry imposed by the Bregman divergence. The following extends the definition of a Stiefel manifold to include a Riemannian metric. Recall that for a strictly convex function G, we have H_{G}∈ [symbol] where [symbol] denotes the set of n×n symmetric positive-definite matrices.

Definition 1 The generalized Stiefel manifold of k-frames in [symbol] with respect to the Riemannian metric M=M(v)∈ [symbol] , v∈ [symbol] is defined as

$$S {t}_{d , k}^{( M )} = \{ U ∈ {ℝ}^{d \times k} : {U}^{T} MU = {I}_{k} \} .$$

Note that for the Euclidean geometry, M(v)=I_{d} for all v∈ [symbol] . Thus, the definition of St_{d,k}^{(M)} recovers St_{d,k}^{(I}^{_{d}}⁾=St_{d,k} and we arrive at the orthonormality in the sense of Euclidean geometry.

This section now formulates the generalized Bregman PCA problem following the local geometry of the strictly convex function at m. Let [symbol] ={xᵢ∈domF*} be a set of given points. Define the generalized Bregman PCA as finding a linear combination of a set of generalized principal directions that minimizes the Bregman compression loss:

$$V , \{ {c}_{i} \} = arg {min}_{\{ \begin{matrix}\tilde{V} ∈ {St}_{d , k}^{( {H}_{F} ( m ) )} , \\ \{ {\tilde{c}}_{i} ∈ {ℝ}^{k} \}\end{matrix} \}} {\sum }_{i} {D}_{F} * ( {x}_{i} , f ( m + \tilde{V} {\tilde{c}}_{i} ) ) , \qquad ( 7 )$$

where H_{F}(m)=∇²F(m). Note that the constraint V∈St_{d,k} in Eq. (1) is now replaced with V∈St^{0.8}(H_F(m))_{d,k}, i.e., using the Riemannian metric induced by the Hessian of the convex function F evaluated at the dual mean m.

### Example Optimization

The generalized Bregman PCA objective in Eq. (7) does not yield a closed-form solution in terms of V and {cᵢ}. However, the problem can be solved iteratively by applications of gradient descent steps on {cᵢ} and V. Let \hat{x}ᵢƒ(m+Vcᵢ) denote the approximation of xᵢ. For the compression coefficients {cᵢ}, one can apply

$${c}_{i}^{new} = {c}_{i} - {η}_{a} {V}^{T} ( {\hat{x}}_{i} - {x}_{i} ) , \qquad ( 8 )$$

where η_{α}>0 denotes the learning rate. Updating V involves two stages: gradient updates followed by a projection onto St^{0.8}(H_F(m))_{d,k}. We apply gradient decent updates,

$${V}^{new} = V - {η}_{V} {\sum }_{i} ( {\hat{x}}_{i} - {x}_{i} ) {c}_{i}^{T} . \qquad ( 9 )$$

where η_{V}>0 denotes the learning rate. The final step involves projecting V onto St_{d,k}^{(H}^{_{F}}^{(m))}. Notice that this projection needs to be applied only once at the end of optimization since both V and {cᵢ} are trained using gradient descent (any intermediate factor can be absorbed into the gradients). For the vanilla PCA where H_{F}(m)=I_{d}, this can be applied easily by an application of QR decomposition. Provided herein is simple modification of the standard QR decomposition algorithm that achieves this for any H_{F}(m)∈ [symbol] , with almost no additional overhead in practice for our application.

### Example Generalized QR Decomposition

A QR decomposition is a factorization of a matrix A∈ [symbol] where n≤m into a product A=QR where Q∈St_{{m,n}} and R∈ [symbol] is an upper-triangular matrix. The first factor Q can be viewed as an orthonormalization of columns of A, similar to the result of a Gram-Schmidt procedure. However, QR decomposition provides a more numerically stable procedure in general. The method of Householder reflections is the most common algorithm for QR decomposition.

The following theorem provides a procedure that extends the standard QR decomposition to produce conjugate factors Q^{T}MQ=Iₙ for a given M∈ [symbol] . T

Theorem 1: Let QR denote the procedure that returns the QR factors. Given M∈ [symbol] and A∈ [symbol] , let \tilde{Q}, R=QR(\sqrt{M}A). Then, the matrix Q=\sqrt{M⁻¹}\tilde{Q} corresponds to the generalized QR decomposition of A such that A=QR and Q^{T}MQ=Iₘ.

The generalized QR decomposition imposes almost no extra overhead compared to standard QR when the matrix M is diagonal. As we will see, this is in fact the case for the local metric induced by the majority of the commonly used transfer functions such as leaky ReLU, sigmoid, and tanh.

### Example Case of Softmax Transfer Function

Consider the case where the input examples are probability distributions {xᵢ∈Δ^{d-1}} belonging to the (d−1)-simplex Δ^{d-1}={u∈ [symbol] |u^{T}1d=1}. The transfer function in this case corresponds to ƒ_{SM}=softmax which induces the KL Bregman divergence

$${D}_{{F}_{SM}^{*}} ( u , v ) = {\sum }_{j} ( {u}_{j} log \frac{{u}_{j}}{{v}_{j}} ) - {u}_{j} + {v}_{j} .$$

Requiring ƒ_{SM} to be inevitable imposes the constraint domf_{SM}= [symbol] −{±c1_{d},c∈ [symbol] } as ƒ_{SM}(u+c1_{d})=ƒ_{SM}(u) for c∈ [symbol] . Thus, for the principal directions, we have 1_{d}∉CS(V) where CS denotes column span. The above constraint can be easily incorporated into the generalized QR decomposition in Algorithm 1 (below) when using the Householder method for the internal QR step.

The Householder method applies a series of reflections

$${P}_{i} = {I}_{m} - 2 \frac{{b}_{i} {b}_{i}^{T}}{{b}_{i}^{T} {b}_{i}} s . t . b ∈ {ℝ}^{m}$$

and i∈[n−1], on matrix A such that

$$R = {P}_{n - 1} {P}_{n - 2} … {P}_{2} {P}_{1} A$$

is upper-triangular. The orthonormal matrix Q then can be written as

$$Q = {P}_{1} {P}_{2} … {P}_{n - 2} {P}_{n - 1} .$$

The following proposition shows that, in order to obtain Q∈St^{(M)}_{d,k} from A s.t. Q^{T}M1=0 using Householder reflections, it suffices to augment A from left by a column of all ones and apply Algorithm 1 (below). The resulting matrix Q corresponds to the first factor when the first column is dropped.

Proposition 2: Given A∈ [symbol] s.t. n<m, let \tilde{Q}, \tilde{R}=GQR([1ₘ, A], M) by applying Algorithm 2.2 using Householder reflections. The Q and R factors, QR=A s.t. Q∈St^{(M)}_{d,k} and Q^{T}M1ₘ=0, can be obtained from Q and R, respectively, by dropping the first columns.

An example generalized Bregman PCA algorithms with a mean is given in Algorithm 2 below. The case of the softmax function in the main algorithm is omitted for simplicity.

### Algorithm 1: GQR(A, M): Generalized QR Decomposition

Input: matrix A∈ [symbol] s.t. n≤m, Riemannian metric M∈ [symbol]
Output: Q∈ [symbol] and R∈ [symbol] factors such that A=QR and Q^{T}MQ=Iₙ

$$\tilde{Q} , R ← Q R ( \sqrt{M} A )$$

$$Q ← \sqrt{{M}^{- 1}} \tilde{Q}$$

Return: Q, R

```
Algorithm 2: Bregman PCA with a Mean
Input: [symbol]     = {xᵢ ∈ domF*}, number of components k
$Output : dual mean m ∈ domF , V ∈ S {t}_{d , k}^{( {H}_{F} ( m ) )} , \{ {c}_{i} ∈ {k}^{} \}$
$m ← f * ( \frac{1}{\vert 𝒳 \vert} {\sum }_{i} {x}_{i} )$
initialize V and {cᵢ}
repeat
  for i ∈ [| [symbol]   |] do
  $\begin{matrix}{\hat{x}}_{i} ← f ( m + V {c}_{i} ) \\ {c}_{i} ← {c}_{i} - {η}_{a} {V}^{T} ( {\hat{x}}_{i} - {x}_{i} ) \\ V ← V - {η}_{0.5} V {\sum }_{i} ( {\hat{x}}_{i} - {x}_{i} ) {c}_{i}^{T}\end{matrix}$
until V, {cᵢ} not converged
V, T ← GQR(V, H_{F}(m))
return m, V, {Tcᵢ}
```

### Example Representation Learning of Deep Neural Networks

One example application of the Bregman PCA described herein is learning the representations of a deep neural network in each layer. Specifically, in a deep neural network, each layer transforms the representation that receives from the previous layer and passes it to the next layer. In a given layer, some example implementations are configured to learn the mean and principal directions that can encapsulate the representations of all training examples in that layer. Although vanilla PCA might be a possible choice for this purpose, learning better representations can be accomplished using the proposed extended Bregman PCA approach.

A natural choice of a Bregman divergence for a layer having a strictly increasing transfer function is the one induced by the convex integral function of the transfer function. In Bregman PCA, we essentially minimize the matching loss of the transfer function ƒ instead of the quadratic compression loss used for vanilla PCA.

Specifically, let [symbol] ∈ [symbol] and [symbol] ∈ [symbol] respectively be the pre and post (transfer function) activations of a neural network for a given input example xᵢ at layer [symbol] ∈[L] having a (elementwise) strictly increasing transfer function [symbol] s.t. [symbol] = [symbol] ( [symbol] ). Let [symbol] denote the convex integral function of [symbol] where [symbol] =∇ [symbol] . Then, for a given set of input examples [symbol] ={xᵢ} having post-activation representations [symbol] ={ [symbol] }, we can cast the Bregman PCA problem in layer [symbol] ∈[L] as learning [symbol] ∈S [symbol] and { [symbol] } with

$${m}^{( ℓ )} = {f}^{* ( ℓ )} ( \frac{1}{\vert {𝒴}^{( ℓ )} \vert} {\sum }_{i} {y}_{i}^{( ℓ )} )$$

that minimize the objective

$${\sum }_{i} {D}_{{F}^{* ( ℓ )}} . ( {y}_{i}^{( ℓ )} , {f}^{ℓ} ( {m}^{( ℓ )} + {V}^{( ℓ )} {c}_{i}^{( ℓ )} ) ) . \qquad ( 10 )$$

Several ideas based on this layerwise construction are described herein, including learning the principal directions in each layer. Specifically, some example implementations perform representation learning in the final softmax layer as well as the fully-connected leaky ReLU layer before the final softmax layer of a ResNet-18 model. However, the proposed construction is applicable to other types of layers, such as convolutions. Some example implementations perform knowledge distillation using the representations learned from a ResNet-18 teacher model to train a smaller convolutional student model on the same dataset.

One example approach includes learning the dual mean m and the principal V in the [symbol] -th layer of the student network. The representation [symbol] of a training example xᵢ is then approximated by [symbol] = [symbol] (Vcᵢ+m) where the compression coefficients cᵢ∈ [symbol] are predicted by a smaller student network. The approximated representation [symbol] can then be passed through the rest of the pre-trained teacher network or a smaller network that is trained from scratch to predict the output labels. This approach can easily be extended to distilling information from several different layers of the teacher model, where one can use a cascade of student networks in which the approximate output representation produced by the previous student network is passed as input to the next student network.

### Example Model Arrangements

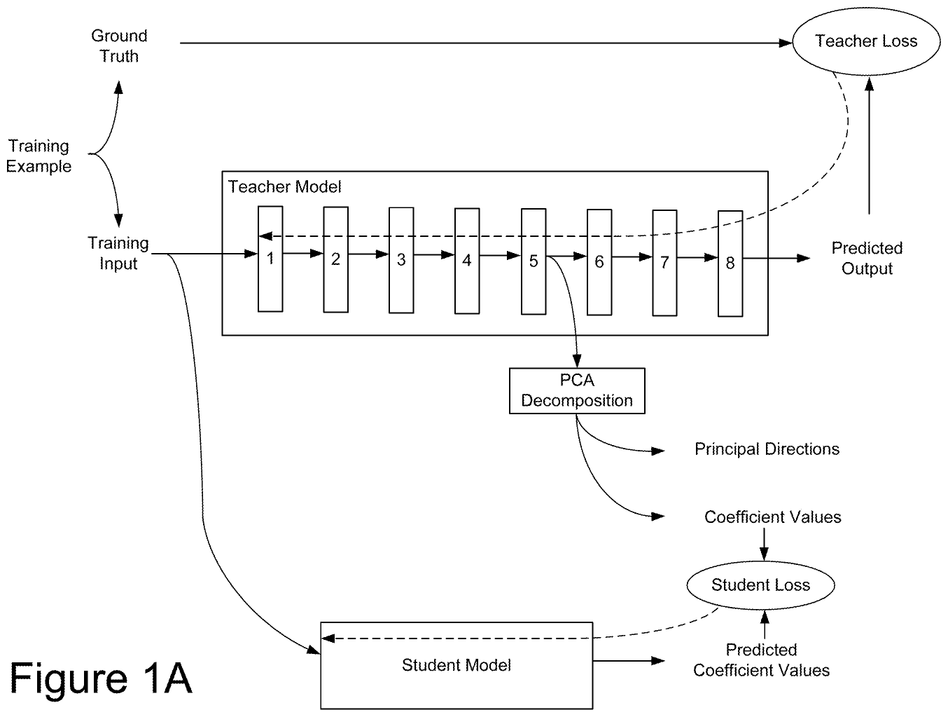

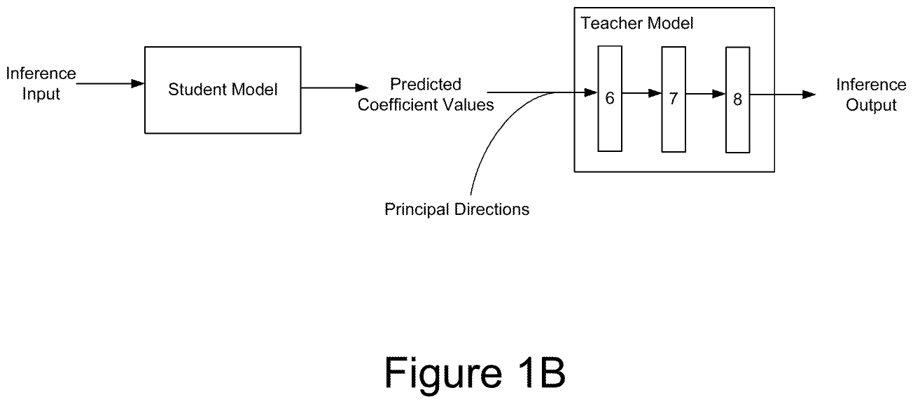

FIGS. 1A-3B depict different model arrangements which serve as examples of approaches to train and perform inference with models having improved computational efficiency. In particular, referring first to FIG. 1A, FIG. 1A depicts a technique to train a student model to predict coefficient values derived by performance of a PCA technique on a representation generated by a layer of a teacher model.

Specifically, FIG. 1A depicts a teacher model and a student model. The teacher model may optionally be pre-trained. The teacher model may also optionally be simultaneously trained with the student model, as shown with the depicted teacher loss. The teacher model is shown as having eight layers for simplicity of description and illustration. The teacher model may have any number of layers.

As shown in FIG. 1A, the teacher model can receive a training input. The teacher model can process the training input to produce a predicted output. The predicted output can optionally be compared to a ground truth using a teacher loss. The teacher model can optionally be trained based on the teacher loss (e.g., by backpropagating the teacher loss through the layers of the teacher model.

As part of processing the training input to generate the predicted output, the teacher model can also generate one or more layer representations at each of its layers. These representations can also be referred to in some instances as embeddings. As one example, layer 5 of the teacher model can generate a layer representation which is passed to layer 6, and so on.

According to an aspect of the present disclosure, to generate a more computationally efficient model, the student model can be trained to predict coefficient values generated by performance of a PCA technique on the layer representations of one or more of the layers of the teacher model.

In particular, as part of the training scheme shown in FIG. 1A, a computing system can perform a PCT technique on the layer representation generated by layer 5 of the teacher machine learning model to generate (i) one or more sets of coefficient values and (ii) a plurality of principal directions. The sets of coefficient values can correspond to the principal directions. Layer 5 is used as an example for the purpose of illustration only. Any one or more of the layers of the teacher can be selected rather than layer 5. For example, the representation (e.g., probability representation) output by layer 8 could be used instead of the representation output by layer 5. Similarly, layer 6 could be used instead, etc.

In some implementations, performing, by the computing system, the principal components analysis technique can include performing, by the computing system, a Bregman principal components analysis technique.

In some implementations, performing, by the computing system, the Bregman principal components analysis technique can further generate (iii) a generalized mean vector. In some implementations, the generalized mean vector can include mean vector values that minimize a Bregman compression loss. In some implementations, the generalized mean vector can be or include an inverse of an activation function of the layer of the teacher machine learning model applied to a mean of the one or more sets of coefficient values as an operator.

In some implementations, performing, by the computing system, the Bregman principal components analysis technique can include enforcing an orthonormality constraint expressed with a Riemannian metric. In some implementations, performing, by the computing system, the Bregman principal components analysis technique can include performing a QR decomposition technique such that a transpose of a first factor matrix times the Riemannian metric times the first factor matrix equals an identity matrix.

Referring again to FIG. 1A, the student machine learning model can be trained to predict the one or more sets of coefficient values. For example, as shown in FIG. 1A, the student model can be trained to predict the coefficient values when given the training input as an input. For example, a student loss can compare the predicted coefficient values with the actual coefficient values. The student loss can, for example, be backpropagated through the student model. In some implementations, the teacher loss can also be backpropagated through the student model.

Although FIG. 1A shows a single training example, the illustrated approach can be performed on a plurality of training examples. For example, a training batch can include a plurality of training examples and the PCA decomposition can be performed over a batch of representations generated by the layer(s) (e.g., layer 5) of the teacher model.

After the student model has been trained as shown in FIG. 1A, the student model can be used to perform inference in a more computationally efficient manner, e.g., as shown in FIG. 1B. In particular, FIG. 1B shows an inference scheme in which the trained student model receives and processes an inference input to generate predicted coefficient values. The predicted coefficient values are then combined with the principal directions stored from the process shown in FIG. 1A to generate an input for a prediction model which generates an inference output.

In FIG. 1B, the prediction model is the remainder of the teacher model (e.g., layers 6, 7, 8). However, in other examples, a different (e.g., new) prediction model or prediction head could be trained rather than using the remainder of the teacher model.

As illustrated in FIG. 1B, because the student model will typically be smaller (e.g., in number of parameters, latency, etc.) than layers 1-5 of the teacher model, the inference shown in FIG. 1B is more computationally efficient, e.g., as compared to simply using the teacher model to perform inference. However, although efficiency gains can be achieved through distillation to a student model that is smaller, the present disclosure is equally applicable to situations in which efficiency gains are achieved through distillation to a student model that is more efficient for other reasons besides “size”, such as architecture type, hardware optimization, etc.

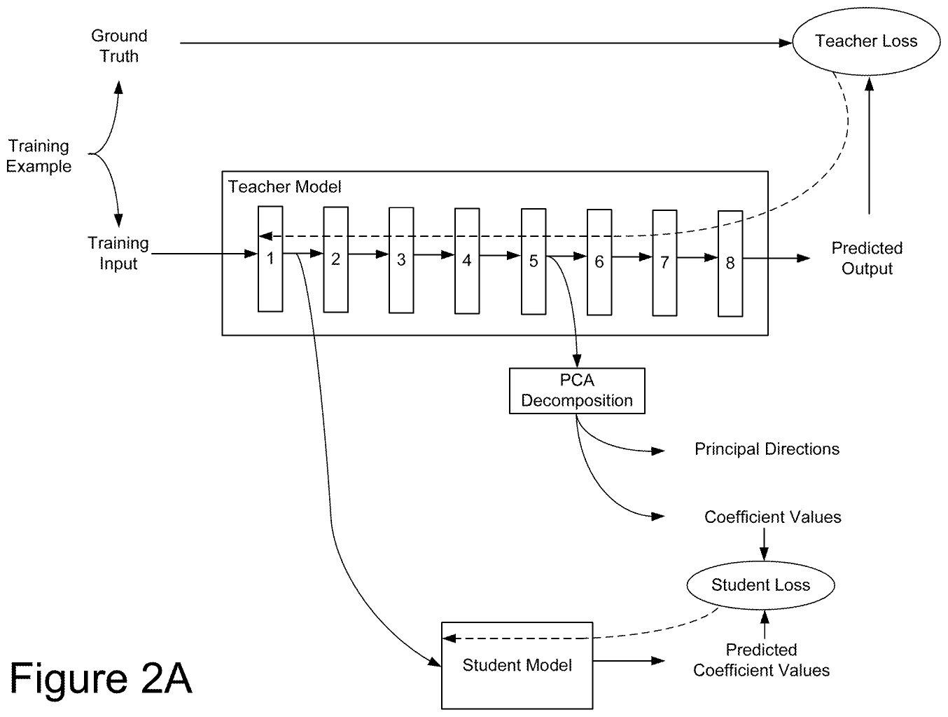

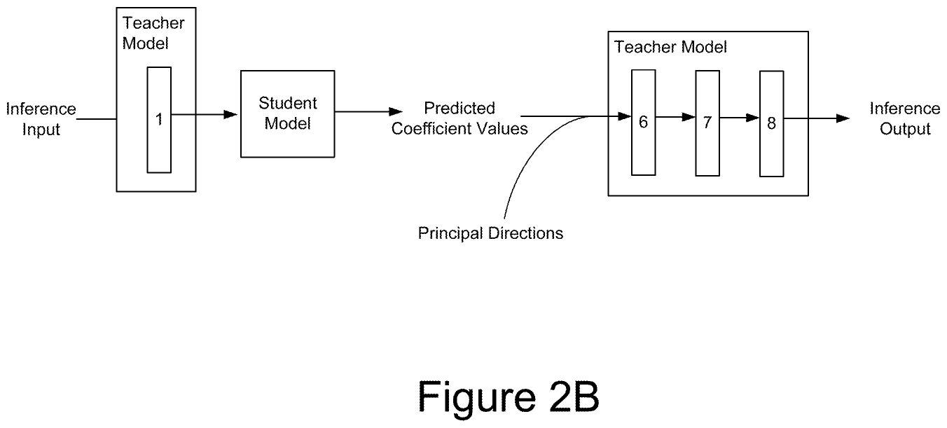

FIGS. 2A and 2B depict block diagrams of an example approach to train and performance inference with models having improved computational efficiency. In particular, FIGS. 2A and 2B are significantly similar to FIGS. 1A and 1, with the exception that the student model does not directly receive the training input in FIG. 2A or the inference input in FIG. 2B. Instead, in FIG. 2A, the student model receives the layer representation output by layer 1 of the teacher model. Again layer 1 is used as an example only, any layer can be used so long as it precedes the layer for which the student predicts coefficient values. Similarly, with reference to FIG. 2B, when performing inference the student model does not directly receive the inference input, but instead receives the output of layer 1 of the teacher model.

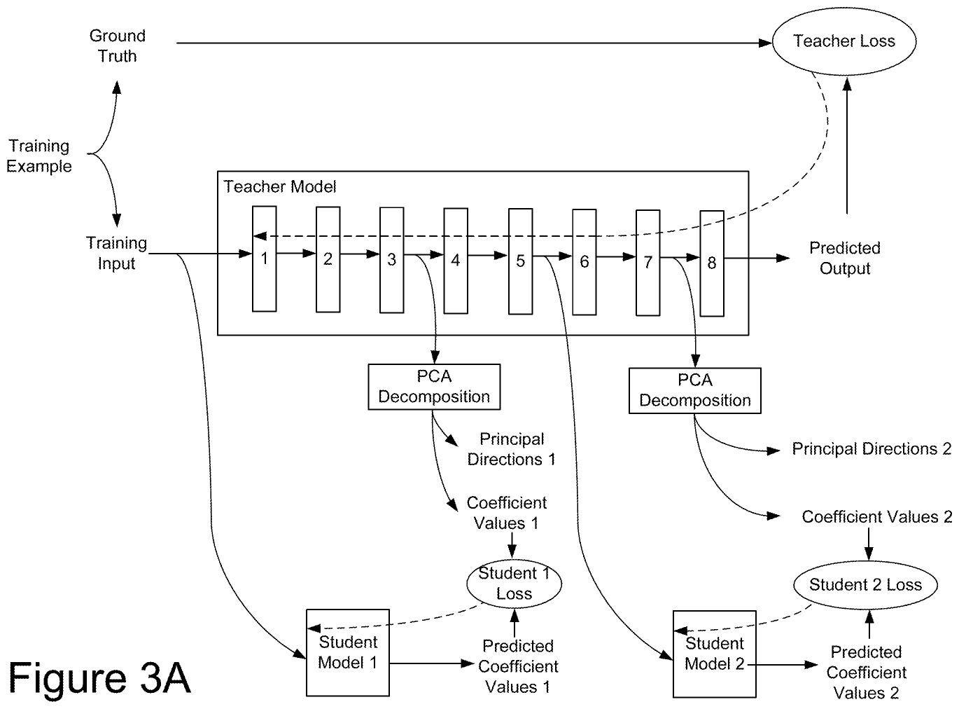

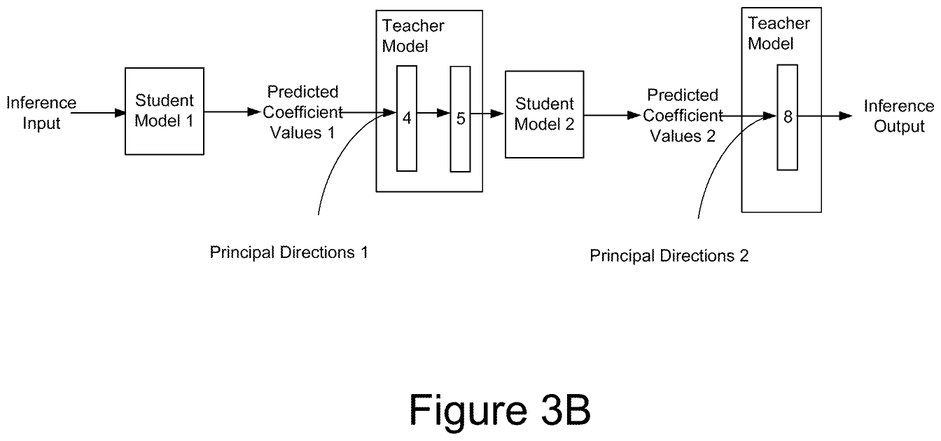

FIGS. 3A and 3B depict block diagrams of an example approach to train and performance inference with models having improved computational efficiency. In particular, FIGS. 3A and 3B are significantly similar to FIGS. 1A and 1B and 2A and 2B, with the exception that in FIGS. 3A and 3B multiple student models are used. For example, in FIG. 3A, a first student model receives the training input and is trained to predict the coefficient values of the layer representation output by layer 3 of the teacher model. Similarly, referring still to FIG. 3A, a second student model receives the output of layer 5 of the teacher model and is trained to predict the coefficient values of the layer representation output by layer 7 of the teacher model. The use of two students and their specific layer relationships is provided as an example only. Any number of student models could be used. FIG. 3B shows how the training approach shown in FIG. 3A could result in an inference model with improved efficiency.

### Example Devices and Systems

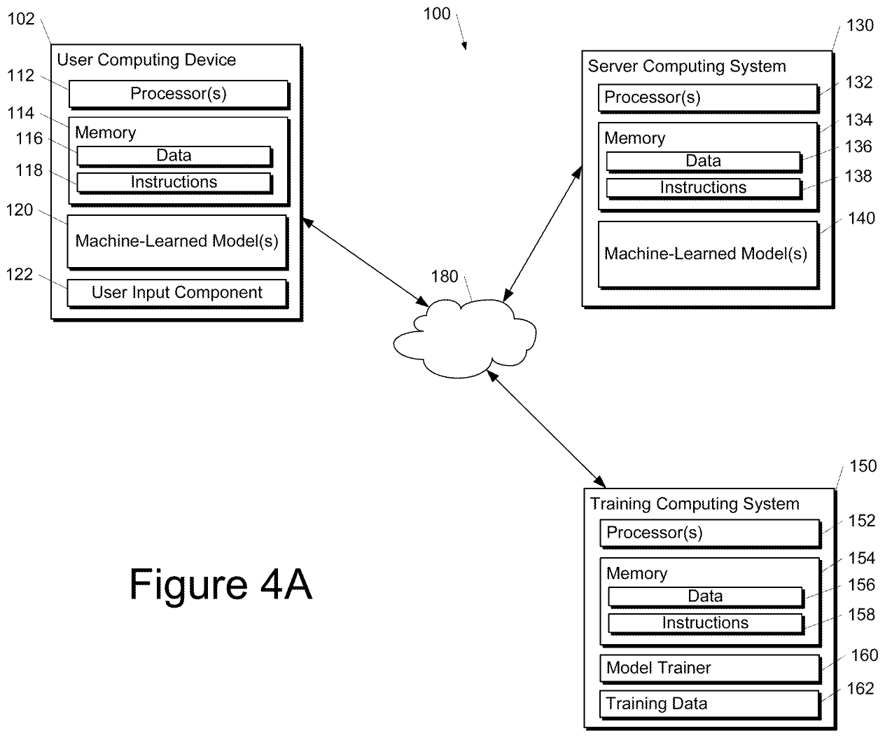

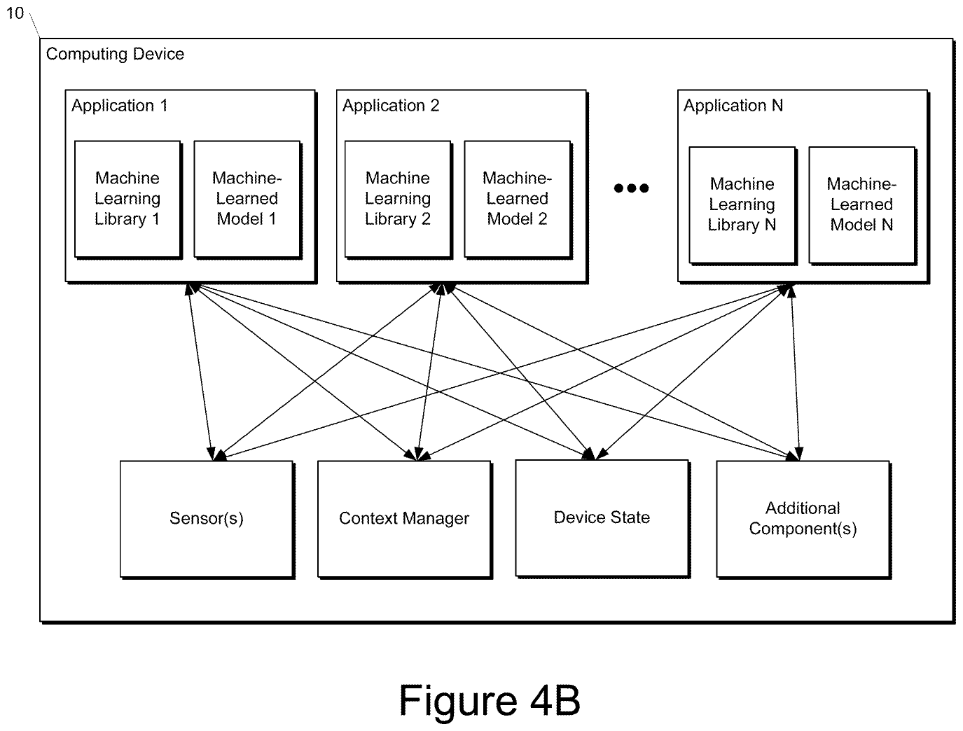

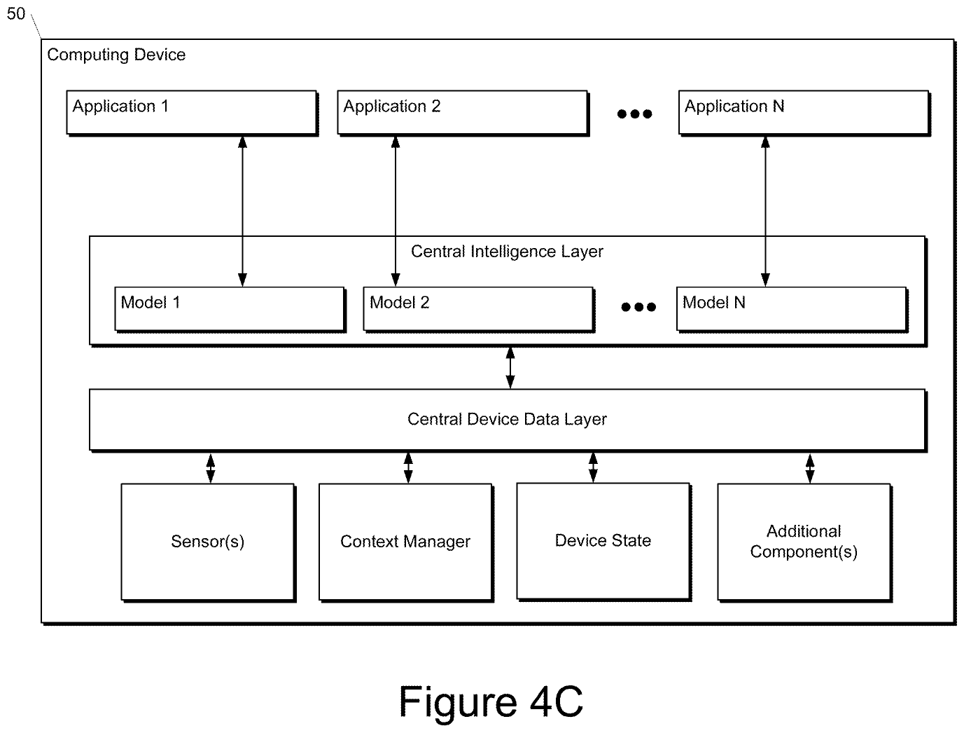

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1A-3B.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel inference across multiple instances of inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1A-3B.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to generate machine learning models having improved computational efficiency, the method comprising:
obtaining, by a computing system comprising one or more computing devices, one or more training inputs;
processing, by the computing system, the one or more training inputs with at least a portion of a teacher machine learning model to generate one or more layer representations at a layer of the teacher machine learning model;
performing, by the computing system, a principal components analysis technique on the one or more layer representations generated by the layer of the teacher machine learning model to generate (i) one or more sets of coefficient values respectively for the one or more layer representations and (ii) a plurality of principal directions, wherein the set of coefficient values for each layer representation comprises a plurality of coefficient values respectively associated with the plurality of principal directions; and
training, by the computing system, a student machine learning model to predict the one or more sets of coefficient values.

2. The computer-implemented method of claim 1, wherein performing, by the computing system, the principal components analysis technique comprises performing, by the computing system, a Bregman principal components analysis technique.

3. The computer-implemented method of claim 2, wherein performing, by the computing system, the Bregman principal components analysis technique comprises further generating (iii) a generalized mean vector.

4. The computer-implemented method of claim 3, wherein the generalized mean vector comprises mean vector values that minimize a Bregman compression loss.

5. The computer-implemented method of claim 3, wherein the generalized mean vector comprises an inverse of an activation function of the layer of the teacher machine learning model applied to a mean of the one or more sets of coefficient values as an operator.

6. The computer-implemented method of any of claim 2, wherein performing, by the computing system, the Bregman principal components analysis technique comprises enforcing an orthonormality constraint expressed with a Riemannian metric.

7. The computer-implemented method of claim 6, wherein performing, by the computing system, the Bregman principal components analysis technique comprises performing a QR decomposition technique such that a transpose of a first factor matrix times the Riemannian metric times the first factor matrix equals an identity matrix.

8. The computer-implemented method of claim 1, wherein:
obtaining, by the computing system, the one or more training inputs comprises obtaining, by the computing system, a plurality of training inputs;
processing, by the computing system, the one or more training inputs with at least the portion of the teacher machine learning model to generate the one or more layer representations at the layer of the teacher machine learning model comprises processing, by the computing system, the plurality of training inputs with at least the portion of the teacher machine learning model to respectively generate a plurality of layer representations at the layer of the teacher machine learning model;
performing, by the computing system, the principal components analysis technique on the one or more layer representations comprises performing, by the computing system, the principal components analysis technique on the plurality of layer representations to generate (i) a plurality of sets of coefficient values respectively for the plurality of layer representations and (ii) a plurality of principal directions, wherein the set of coefficient values for each layer representation comprises a plurality of coefficient values respectively associated with the plurality of principal directions; and
training, by the computing system, the student machine learning model to predict the one or more sets of coefficient values comprises training, by the computing system, the student machine learning model to predict the plurality of sets of coefficient values.

9. The computer-implemented method of claim 1, wherein training, by the computing system, the student machine learning model to predict the one or more sets of coefficient values comprises training, by the computing system, the student machine learning model to predict the one or more sets of coefficient values when given the one or more training inputs as input.

10. The computer-implemented method of claim 1, wherein training, by the computing system, the student machine learning model to predict the one or more sets of coefficient values comprises training, by the computing system, the student machine learning model to predict the one or more sets of coefficient values when given a prior layer representation as an input, the prior layer representation generated by a second layer of the teacher machine learning model that is prior to the layer of the teacher machine learning model.

11. The computer-implemented method of claim 1, wherein the layer of the teacher machine learning model comprises a hidden layer and the one or more layer representations comprise one or more embeddings.

12. The computer-implemented method of any of claim 1, wherein the layer of the teacher machine learning model comprises an output layer and the one or more layer representations comprise one or more output probability representations.

13. The computer-implemented method of claim 1, further comprising, after training, by the computing system, the student machine learning model to predict the one or more sets of coefficient values:
training, by the computing system, a prediction model to predict one or more ground truth labels associated with the one or more training inputs when given the one or more training inputs as input, the prediction model comprising the student machine learning model, a prediction head, and the plurality of principal directions.

14. The computer-implemented method of claim 1, further comprising, simultaneous to training the student machine learning model to predict the one or more sets of coefficient values:
training, by the computing system, the teacher machine learning model to predict one or more ground truth labels associated with the one or more training inputs when given the one or more training inputs as input;
wherein performing, by the computing system, the principal components analysis technique comprises performing an online principal components analysis technique.

15. The computer-implemented method of claim 1, wherein the teacher machine learning model comprises a pre-trained model.

16. One or more non-transitory computer-readable media that collectively store instructions that, when executed by one or more processors of a computing system, cause the computing system to perform operations, the operations comprising:
obtaining, by a computing system comprising one or more computing devices, one or more training inputs;
processing, by the computing system, the one or more training inputs with at least a portion of a teacher machine learning model to generate a plurality of layer representations respectively at a plurality of layers of the teacher machine learning model; and
for each of the plurality of layers:
performing, by the computing system, a principal components analysis technique on the one or more layer representations generated at the layer to generate (i) one or more sets of coefficient values respectively for the one or more layer representations and (ii) a plurality of principal directions, wherein the set of coefficient values for each layer representation comprises a plurality of coefficient values respectively associated with the plurality of principal directions; and
training, by the computing system, a respective student machine learning model to predict the one or more sets of coefficient values.

17. The one or more non-transitory computer-readable media of claim 16, wherein the principal components analysis technique comprises a Bregman principal components analysis technique.

18. A computing system for generating machine learning predictions with improved efficiency, the computing system comprising:
one or more processors; and
one or more non-transitory computer-readable media that collectively store:
a machine-learned prediction model, comprising:
a plurality of principal directions generated by performance of a principal components analysis on a plurality of layer representations generated at a layer of a teacher machine learning model;
a student machine learning model trained to predict a plurality of predicted coefficient values respectively associated with the plurality of principal directions when given a model input; and
a prediction head configured to generate a model prediction based on the plurality of principal directions and predicted coefficient values; and
instructions that, when executed by the one or more processors, cause the computing system to perform operations, the operations comprising:
obtaining the model input;
processing the model input with the student machine learning model to generate the plurality of predicted coefficient values; and
processing the plurality of principal directions and predicted coefficient values with the prediction head to generate the model output.

19. The computing system of claim 18, wherein the principal components analysis technique comprises a Bregman principal components analysis technique.

20. The computing system of claim 18, wherein the model input comprises an image and the model output comprises an image prediction.
